(19) United States
(12) Patent Application Publication
(10) Pub. No.: US 2026/0238082 A1
(43) Pub. Date: Aug. 13, 2026

(54) ROTATION DRIVE MECHANISM, DRIVING METHOD, COUPLING METHOD, AND COUPLING DEVICE

(71) Applicant: ALL RING TECH CO., LTD., Kaohsiung City (TW)

(72) Inventors: Chun-Hung TSAI, Kaohsiung City (TW); Yu-Sheng GUO, Kaohsiung City (TW)

(21) Appl. No.: 19/435,658

(22) Filed: Dec. 29, 2025

(30) Foreign Application Priority Data
Feb. 11, 2025 (TW) 114105080

(51) Int. Cl. H02K 7/14; G02B 6/36; H02K 41/02

(52) U.S. Cl. CPC H02K 7/14; G02B 6/3604; H02K 41/02

(57) ABSTRACT

A rotation drive mechanism includes a plurality of rotatable assemblies. Each of the plurality of rotatable assemblies includes a base seat and a movable seat. The movable seat of each of the plurality of rotatable assemblies is driven to move arcuately along the base seat of the respective one of the plurality of rotatable assemblies along an arcuate path about an axis.

### CROSS-REFERENCE TO RELATED APPLICATION

This application claims priority to Taiwanese Invention Patent Application No. 114105080, filed on February 11, 2025, the entire disclosure of which is incorporated by reference herein.

### FIELD

The disclosure relates to a rotation drive mechanism, a driving method, a coupling method and a coupling device, and more particularly to a rotation drive mechanism, a driving method, a coupling method and a coupling device for moving a fiber array unit during a process of coupling the fiber array unit to an integrated circuit component.

### BACKGROUND

In a semiconductor manufacturing process, in order to produce chips that have relatively high transmission performance and relatively low power consumption, silicon photonics (SiPh) technology has become the focus of industry development. In silicon photonics technology, such as a pluggable transceiver optics (PTO) infrastructure, an on-board optics (OBO) infrastructure, a co-packaged optics (CPO) infrastructure and an optical input/output (optical I/O) infrastructure, it is necessary to couple a fiber array unit (FAU) to an integrated circuit component. Currently, the process of integrated circuit component packaging has progressed to two-point-five dimensional (2.5D) IC packaging and three-dimensional (3D) IC packaging, and integrated circuit components and fiber optic array units have also been modified in structure with the advancement of the process of integrated circuit component packaging. For example, the integrated circuit component includes photonic integrated circuits (PIC), and the fiber array unit includes optical couplers, receptacle portions and optical fibers that are connected between the optical couplers and the receptacle portions. The photonic integrated circuits of the integrated circuit component are coupled to the optical couplers of the fiber array unit and are in optical communication with the external environment through the optical fibers of the fiber array unit.

During the process for coupling the fiber array unit to the integrated circuit component, the fiber array unit is usually driven to move along a plurality of axes X, Y and Z along which a first direction, a second direction and a third direction respectively extend in a Cartesian coordinate system.

### SUMMARY

Therefore, an object of the present disclosure is to provide a rotation drive mechanism, a driving method, a coupling method, and a coupling device that are different from those of the prior art.

According to an aspect of the disclosure, a rotation drive mechanism includes a plurality of rotatable assemblies. Each of the plurality of rotatable assemblies includes a base seat and a movable seat driven to move arcuately along the base seat along an arcuate path about an axis.

According to another aspect of the disclosure, a driving method adapted for moving a fiber array unit is provided. The driving method includes steps of:

retaining, with a retention mechanism, the fiber array unit;

driving the retention mechanism by a rotation drive mechanism that includes a plurality of rotatable assemblies; and

driving a movable seat of each of the plurality of rotatable assemblies to move arcuately along a base seat of the respective one of the plurality of rotatable assemblies along an arcuate path about an axis.

According to another aspect of the disclosure, a coupling method adapted to couple a fiber array unit to an integrated circuit component is provided. The coupling method includes steps of:

retaining, with a retention mechanism, the fiber array unit;

driving the retention mechanism by a rotation drive mechanism that includes a plurality of rotatable assemblies such that the fiber array unit is moved toward the integrated circuit component;

measuring an intensity of an optical signal transmitted between the fiber array unit and the integrated circuit component; and

driving a movable seat of each of the plurality of rotatable assemblies to move arcuately along a base seat of the respective one of the plurality of rotatable assemblies along an arcuate path about an axis, such that the retention mechanism is driven to adjust a posture of the fiber array unit according to the intensity of the optical signal until the intensity falls within a predetermined range.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an integrated circuit component and a fiber array unit to be coupled to the integrated circuit component by an embodiment of a coupling method according to the present disclosure.

FIG. 2 is a fragmentary schematic sectional view illustrating the fiber array unit coupled to the integrated circuit component.

FIG. 3 is a perspective view of the fiber array unit.

FIG. 4 is a perspective view of the fiber array unit seen from an angle different from FIG. 3.

FIG. 5 is a fragmentary, partly sectional view illustrating an optical signal transmitted between the fiber array unit and the integrated circuit component.

FIG. 6 is a perspective view illustrating an embodiment of a coupling device according to the present disclosure.

FIG. 7 is a partly exploded perspective view illustrating a third straight movement unit of a linear driving mechanism of the coupling device, a rotation drive mechanism, a retention mechanism, and an inspection mechanism.

FIG. 8 is a partly exploded perspective view illustrating a first rotatable assembly, a second rotatable assembly, and a third rotatable assembly of the rotation drive mechanism.

FIG. 9 is a perspective view illustrating a first movable seat of the first rotatable assembly rotatable about a first axis along a first arcuate path relative to a first base seat of the first rotatable assembly.

FIG. 10 is a perspective view illustrating a second movable seat of the second rotatable assembly rotatable about a second axis along a second arcuate path relative to a second base seat of the second rotatable assembly.

FIG. 11 is a perspective view illustrating a third movable seat of the third rotatable assembly rotatable about a third axis along a third arcuate path relative to a third base seat of the third rotatable assembly.

FIG. 12 is a fragmentary side view illustrating a plurality of connection surfaces of the rotation drive mechanism.

FIG. 13 is a fragmentary perspective view illustrating the first axis, the second axis, and the third axis intersecting at an axial point.

FIG. 14 is a partly exploded perspective view of the retention mechanism and a curing unit of the retention mechanism.

FIG. 15 is a fragmentary side view illustrating the retention mechanism and an air passage of the retention mechanism.

FIG. 16 is a fragmentary side view illustrating a retention member of the retention mechanism.

FIG. 17 is a fragmentary perspective view illustrating the retention member that is disposed upside down.

FIG. 18 is a perspective view of a drive unit of the retention mechanism.

FIG. 19 is a perspective view of a connector member of the retention mechanism.

FIG. 20 is a fragmentary schematic side view illustrating the connector member being movable relative to the retention member and detachably connected to the fiber array unit.

FIG. 21 is a fragmentary schematic perspective view illustrating first cure elements of the curing unit emitting ultraviolet light toward the fiber array unit.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

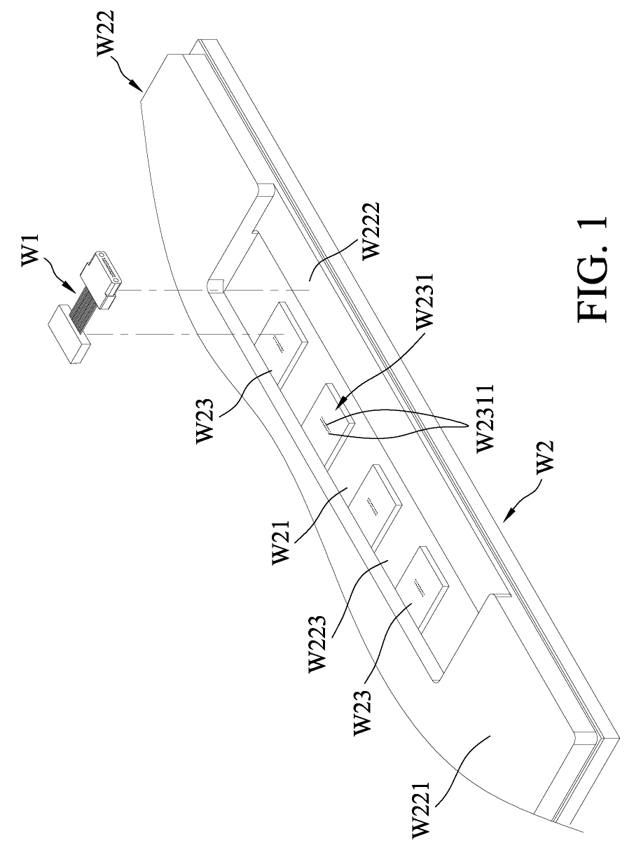

Referring to FIGS. 1, 6 and 7, an embodiment of a coupling method and a driving method according to the present invention is to be implemented by a coupling device 2 that is adapted for retaining and moving a fiber array unit (W1) to couple the fiber array unit (W1) to an integrated circuit component (W2).

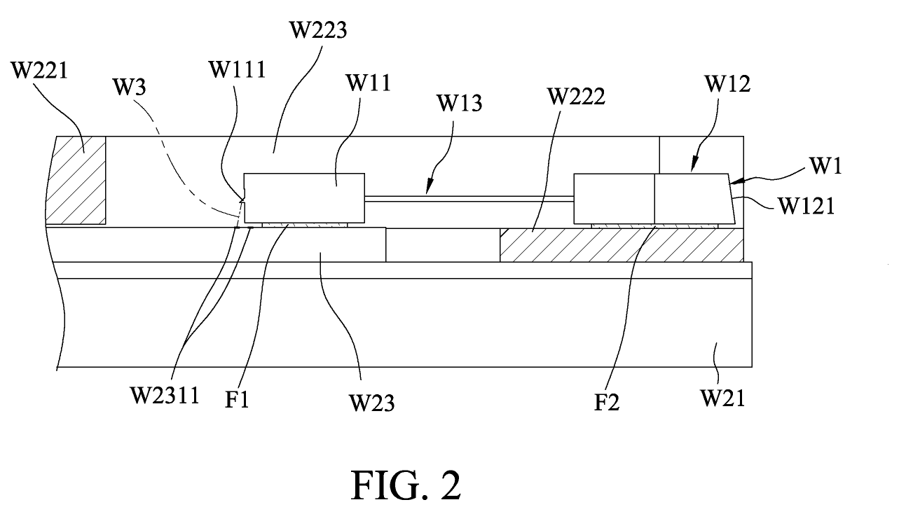

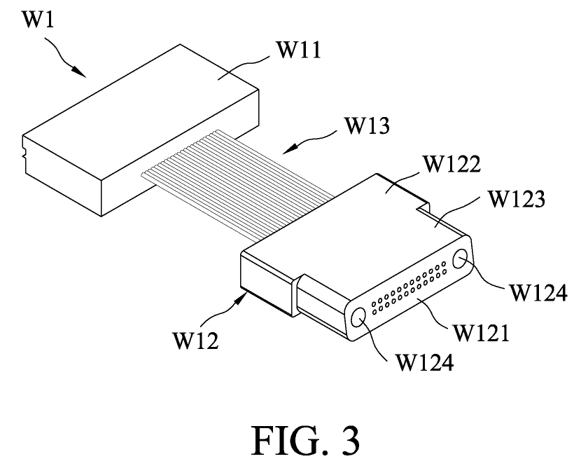

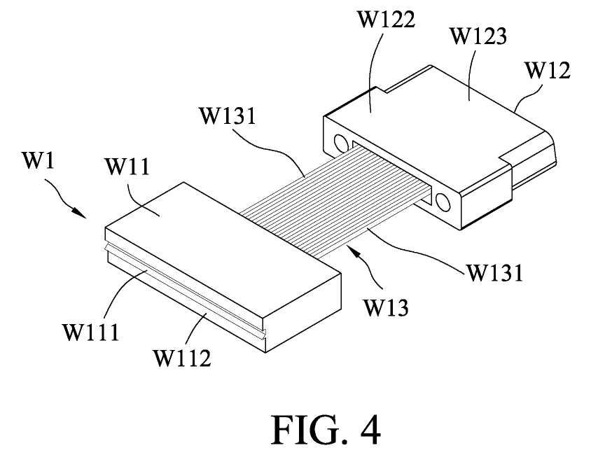

Further referring to FIGS. 2 to 4, the fiber array unit (W1) includes an optical coupler (W11), a receptacle portion (W12), and an optical fiber portion (W13) connected to the optical coupler (W11) and the receptacle portion (W12). The optical coupler (W11) is made of a light-transmissive material and includes a prism (W111) that is formed on a first side surface (W112) of the optical coupler (W11) which is distal from the receptacle portion (W12). The receptacle portion (W12) is provided for the optical fiber portion (W13) to extend therethrough such that the optical fiber portion (W13) is exposed outwardly from a second side surface (W121) of the receptacle portion (W12) that is distal from the optical coupler (W11). The receptacle portion (W12) includes a first seat portion (W122), a second seat portion (W123) having a width smaller than a width of the first seat portion (W122) in a direction transverse to a direction that the optical fiber portion (W13) extends in, and two guide holes (W124) extending through the first seat portion (W122) and the second seat portion (W123). As shown in FIG. 2, the second side surface (W121) of the receptacle portion (W12) is tilted outwardly from top to bottom. The optical fiber portion (W13) includes a plurality of optical fibers (W131) and is flexible.

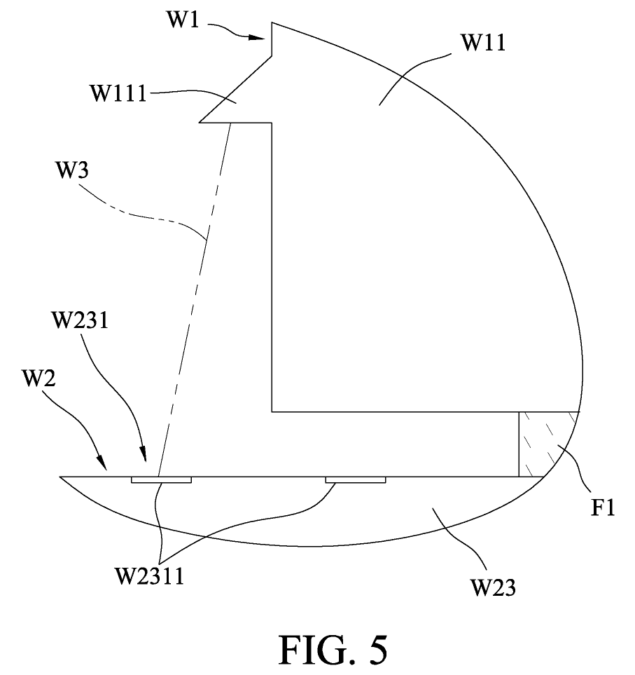

Referring back to FIGS. 1 and 2, the integrated circuit component (W2) includes a carrier board (W21), a lid unit (W22), and a plurality of photonic integrated circuits (W23) disposed on the carrier board (W21). The carrier board (W21) is substantially rectangular and the photonic integrated circuits (W23) are arranged on one side of the carrier board (W21). The lid unit (W22) includes a first lid portion (W221), a second lid portion (W222) that is lower in height than the first lid portion (W221), and a recessed portion (W223) that is disposed between the first lid portion (W221) and the second lid portion (W222) and that exposes the photonic integrated circuits (W23) therefrom. The recessed portion (W223) may be formed according to a design of positions of the photonic integrated circuits (W23). For example, in some embodiments, there are a plurality of recessed portions (W223) disposed adjacent to four sides of the carrier board (W21) that is rectangular. Each of the photonic integrated circuits (W23) includes a lens array (W231). As shown in FIGS. 2 and 5, the lens array (W231) includes a plurality of lenses (W2311) that are arranged as a matrix. It should be noted that since the structures of the photonic integrated circuits (W23) are the same, only one of the photonic integrated circuits (W23) will be described in the following description for the sake of brevity.

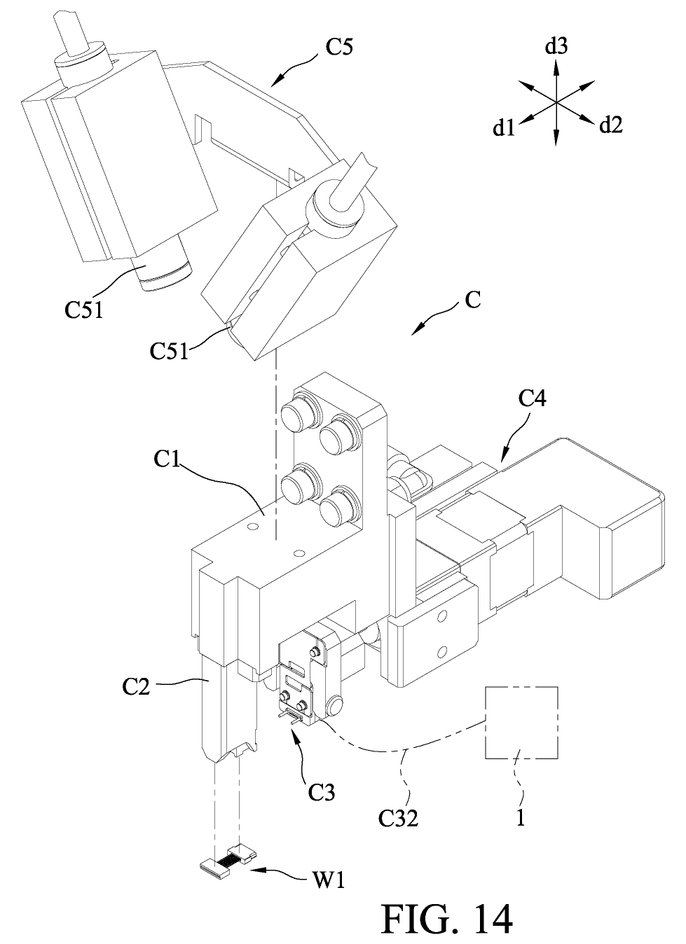

Referring to FIGS. 2 and 5, when the fiber array unit (W1) is coupled to the integrated circuit component (W2), the optical coupler (W11) of the fiber array unit (W1) is in contact with and abuts against the photonic integrated circuit (W23) and the receptacle portion (W12) is in contact with the second lid portion (W222) of the lid unit (W22). The prism (W111) of the optical coupler (W11) of the fiber array unit (W1) is disposed to correspond in position to the lens array (W231) of the photonic integrated circuit (W23) such that an optical signal (W3) is transmitted between the prism (W111) of the fiber array unit (W1) and the lens array (W231) of the photonic integrated circuit (W23). The optical signal (W3) is outputted from a measurement unit 1 (see FIG. 14), is transmitted to the integrated circuit component (W2) via the fiber array unit (W1), and then is transmitted back to the fiber array unit (W1) from the integrated circuit component (W2). The measurement unit 1 is configured to measure an intensity of the optical signal (W3) transmitted back to the fiber array unit (W1) from the photonic integrated circuit (W23) of the integrated circuit component (W2). Specifically, when the optical signal (W3) is transmitted to the photonic integrated circuit (W23), the optical signal (W3) outputted from the fiber array unit (W1) is refracted by the prism (W111) and propagates inclinedly, forwardly and downwardly as depicted in FIG. 5 to enter the lenses (W2311) of the lens array (W231). The optical coupler (W11) and the photonic integrated circuit (W23) may be connected to each other by a first adhesive (F1), and the receptacle portion (W12) and the lid unit (W22) may be connected to each other by a second adhesive (F2) (see FIG. 2). In this embodiment, the first adhesive (F1) is ultraviolet cured adhesive, and the second adhesive (F2) is heat cured adhesive. It should be noted that, in other embodiments of the present disclosure, the second lid portion (W222) may be omitted, and the lid unit (W22) may only include the first lid portion (W221), so that the receptacle portion (W12) is in contact with and abuts against the carrier board (W21).

It should be noted that in the following descriptions, the coupling device 2 will be described first and the coupling method and the driving method will be described later. The coupling device 2 is for retaining and moving the fiber array unit (W1), and for coupling the fiber array unit (W1) to the integrated circuit component (W2). Specifically, the coupling device 2 includes a linear driving mechanism (A) that is disposed on a machine bed (T), a rotation drive mechanism (B) that is disposed on the linear driving mechanism (A) and that is driven by the linear driving mechanism (A) to move linearly in a plurality of directions, a retention mechanism (C) that is disposed on the rotation drive mechanism (B), that is driven by the rotation drive mechanism (B) to rotate about a plurality of axes, and that is driven to move linearly and rotate respectively by the linear driving mechanism (A) and the rotation drive mechanism (B), and an inspection mechanism (D) that is disposed on the linear driving mechanism (A) and that is driven by the linear driving mechanism (A) to move linearly in the plurality of directions and that is for inspecting a posture (a position and/or an inclination degree, which will be described in the following) of the integrated circuit component (W2) (see FIG. 1).

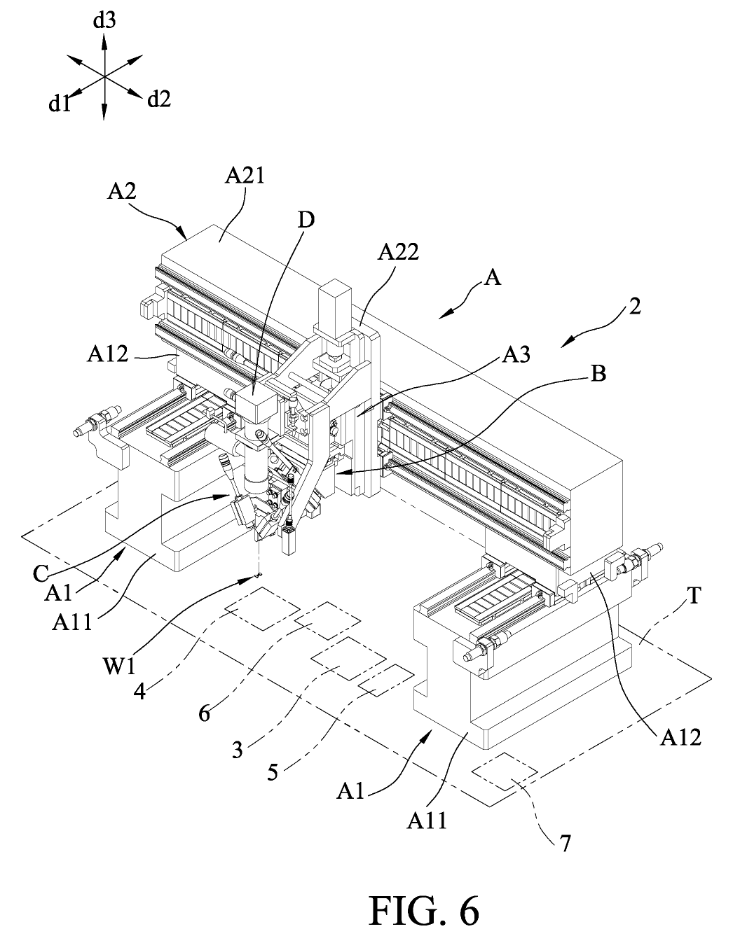

Referring to FIG. 6, in the following description, a first direction (d1) is a horizontal direction, a second direction (d2) is another horizontal direction normal to the first direction (d1), and a third direction (d3) is a vertical direction normal to the first direction (d1) and the second direction (d2). In this embodiment, the first direction (d1) is a front-rear direction, the second direction (d2) is a left-right direction, and the third direction (d3) is an up-down direction. In this embodiment, a first stage device 3, a second stage device 4, an adhesive coating station 5, a detection station 6, and a control unit 7 are disposed on the machine bed (T).

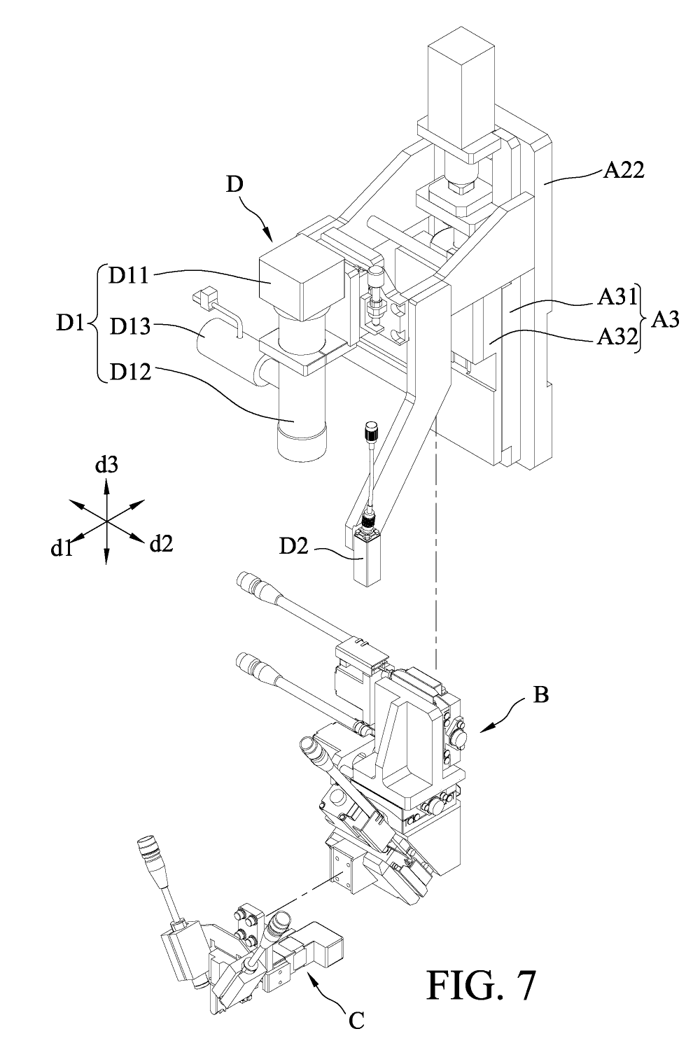

Referring to FIGS. 6 and 7, the linear driving mechanism (A) includes a first straight movement unit (A1) disposed on the machine bed (T), a second straight movement unit (A2) mounted to the first straight movement unit (A1), and a third straight movement unit (A3) mounted to the second straight movement unit (A2). The first straight movement unit (A1) is operable to drive the rotation drive mechanism (B) to move linearly in the first direction (d1), and includes two first rail seats (A11) disposed on the machine bed (T) and spaced apart from each other in the second direction (d2), and two first slide seats (A12) disposed respectively on the first rail seats (A11). The first rail seats (A11) extend in the first direction (d1), and each of the first slide seats (A12) is movable along the respective one of the first rail seats (A11) in the first direction (d1). The second straight movement unit (A2) is operable to drive the rotation drive mechanism (B) to move linearly in the second direction (d2), and includes a second rail seat (A21) disposed across the first slide seats (A12), and a second slide seat (A22) mounted to the second rail seat (A21). The second rail seat (A21) extends in the second direction (d2), and the second slide seat (A22) is movable along the second rail seat (A21) in the second direction (d2). The third straight movement unit (A3) is operable to drive the rotation drive mechanism (B) to move linearly in the third direction (d3), and includes a third rail seat (A31) mounted to the second slide seat (A22) and a third slide seat (A32) mounted to the third rail seat (A31). The third rail seat (A31) extends in the third direction (d3), and the third slide seat (A32) is movable along the third rail seat (A31) in the third direction (d3). One or more of the first straight movement unit (A1), the second straight movement unit (A2), and the third straight movement unit (A3), drives the rotation drive mechanism (B) to move linearly such that the retention mechanism (C) drives linear movements of the fiber array unit (W1) in one or more of the first direction (d1), the second direction (d2), and the third direction (d3). In this embodiment, the first straight movement unit (A1) and the second straight movement unit (A2) employ linear motors to drive movements of the first slide seats (A12) and the second slide seat (A22), but the present disclosure is not limited thereto. In other embodiments, a combination of a screw rod and a rotary motor may be utilized to drive movement of the first slide seats (A12) and the second slide seat (A22). It should be noted that in this embodiment, the third straight movement unit (A3) drives movement of the third slide seat (A32) through a combination of a rotary motor and a screw rod, but the present disclosure is not limited thereto. For example, the third straight movement unit (A3) may drive movement of the third slide seat (A32) through a linear motor in other embodiments of the present disclosure.

Referring to FIG. 7, the inspection mechanism (D) includes an image capturing unit (D1) and a distance sensor (D2). The image capturing unit (D1) includes an imager (D11), a lens (D12), and a light source (D13). Referring back to FIG. 1, the image capturing unit (D1) is disposed above the photonic integrated circuit (W23) and the lens array (W231) of the photonic integrated circuit (W23) of the integrated circuit component (W2) for capturing an image of the photonic integrated circuit (W23) and/or the lens array (W231) to obtain a position of the photonic integrated circuit (W23) and/or the lens array (W231). The image capturing unit (D1) may be, e.g., a charge coupled device (CCD) camera and the imager (D11) may be, e.g., an image processor. The distance sensor (D2) may be, e.g., an optical reflective sensor that is for sensing a distance between the distance sensor (D2) and each of at least three points on an upper surface of the photonic integrated circuit (W23) that are not collinear to obtain an inclination degree of the upper surface of the photonic integrated circuit (W23) relative to a horizontal plane normal to the third direction (d3). That is to say, the inspection mechanism (D) inspects the posture of the integrated circuit component (W2) through obtaining the position of the photonic integrated circuit (W23) and/or the lens array (W231) using the image capturing unit (D1), and obtaining the inclination degree of the upper surface of the photonic integrated circuit (W23) using the distance sensor (D2).

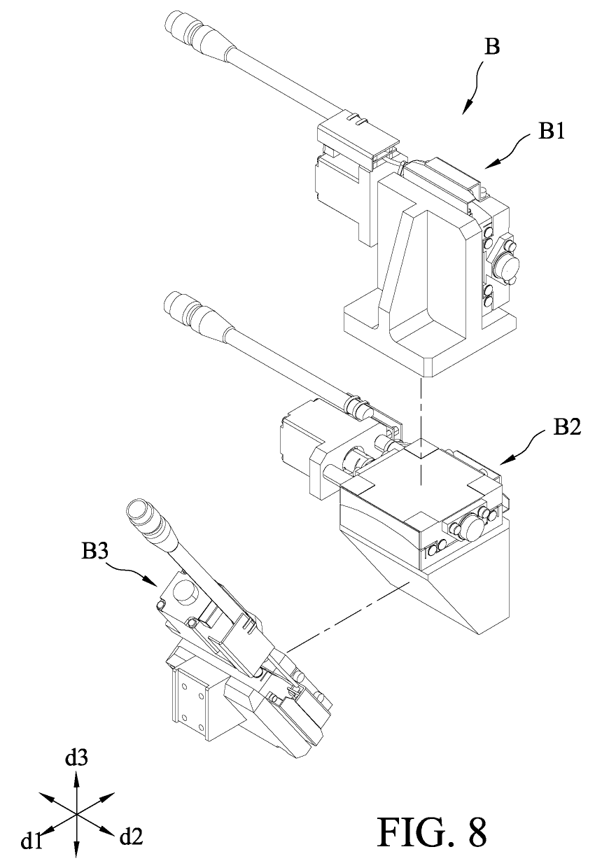

Referring to FIGS. 7 and 8, the rotation drive mechanism (B) includes a first rotatable assembly (B1) mounted to the third slide seat (A32) of the third straight movement unit (A3) of the linear driving mechanism (A), a second rotatable assembly (B2) mounted to the first rotatable assembly (B1), and a third rotatable assembly (B3) mounted to the second rotatable assembly (B2).

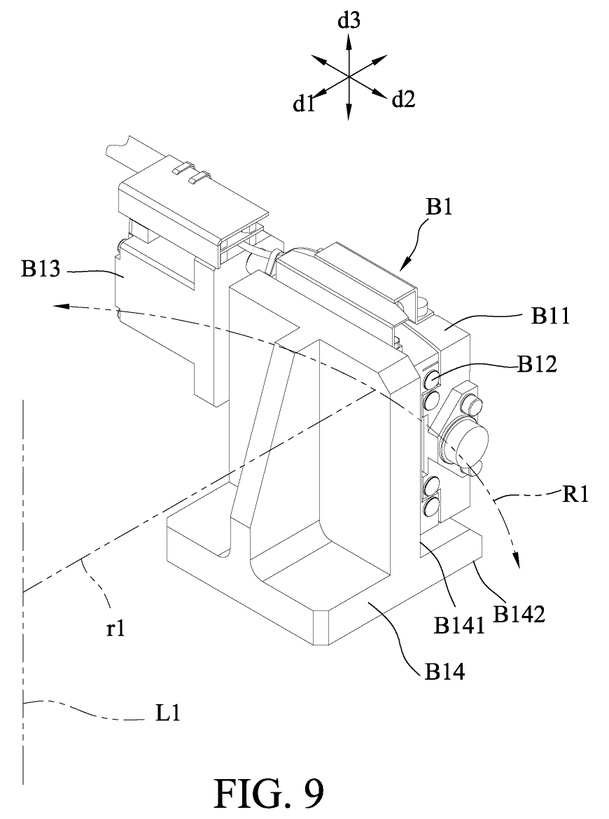

Referring to FIGS. 8 and 9, the first rotatable assembly (B1) is operable to drive the retention mechanism (C) (see FIG. 7) to rotate about a first axis (L1), and includes a first base seat (B11) mounted to the third slide seat (A32) (see FIG. 7), a first movable seat (B12) mounted to the first base seat (B11), a first driver (B13) operable to drive the first movable seat (B12) to move, and a first connecting member (B14) mounted to the first movable seat (B12). The first base seat (B11) is formed with an arcuate concave surface that faces the first movable seat (B12). The first movable seat (B12) is formed with an arcuate convex surface that faces the first base seat (B11) and that is complementary in shape with the arcuate concave surface of the first base seat (B11). The first movable seat (B12) is driven by the first driver (B13) to move arcuately along the first base seat (B11) so that the first connecting member (B14) is driven thereby to move along a first arcuate path (R1) left and right as depicted in FIG. 9. The first movable seat (B12) rotates about the first axis (L1) that is parallel to the third direction (d3). As shown in FIG. 9, a distance between each of a plurality of points on the first arcuate path (R1) and the first axis (L1) is defined as a first radius (r1). In this embodiment, the first base seat (B11) and the first movable seat (B12) are movable relative to each other through a cross bearing, but the present disclosure is not limited hereto.

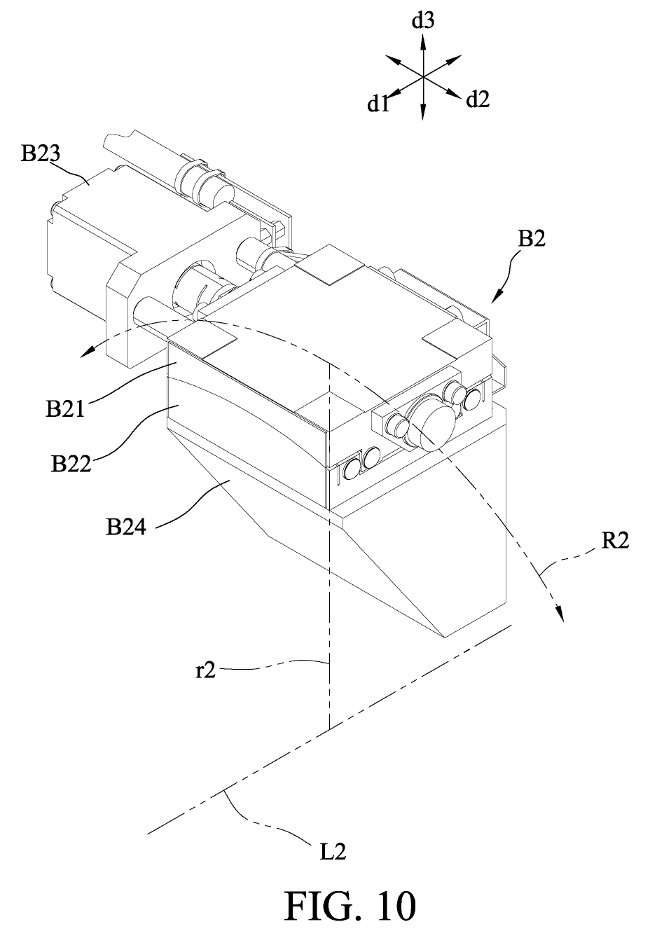

Referring to FIGS. 8 and 10, the second rotatable assembly (B2) is operable to drive the retention mechanism (C) (see FIG. 7) to rotate about a second axis (L2), and includes a second base seat (B21) mounted to the first connecting member (B14) (see FIG. 9), a second movable seat (B22) mounted to the second base seat (B21), a second driver (B23) operable to drive the second movable seat (B22) to move, and a second connecting member (B24) mounted to the second movable seat (B22). The second base seat (B21) is formed with an arcuate concave surface that faces the second movable seat (B22). The second movable seat (B22) is formed with an arcuate convex surface that faces the second base seat (B21) and that is complementary in shape with the arcuate concave surface of the second base seat (B21). The second movable seat (B22) is driven by the second driver (B23) to move arcuately along the second base seat (B21) so that the second connecting member (B24) is driven thereby to move along a second arcuate path (R2) up and down as depicted in FIG. 10 The second movable seat (B22) rotates about the second axis (L2) that is parallel to the first direction (d1). As shown in FIG. 10, a distance between each of a plurality of points on the second arcuate path (R2) and the second axis (L2) is defined as a second radius (r2). In this embodiment, the second base seat (B21) and the second movable seat (B22) are movable relative to each other through a cross bearing, but the present disclosure is not limited hereto.

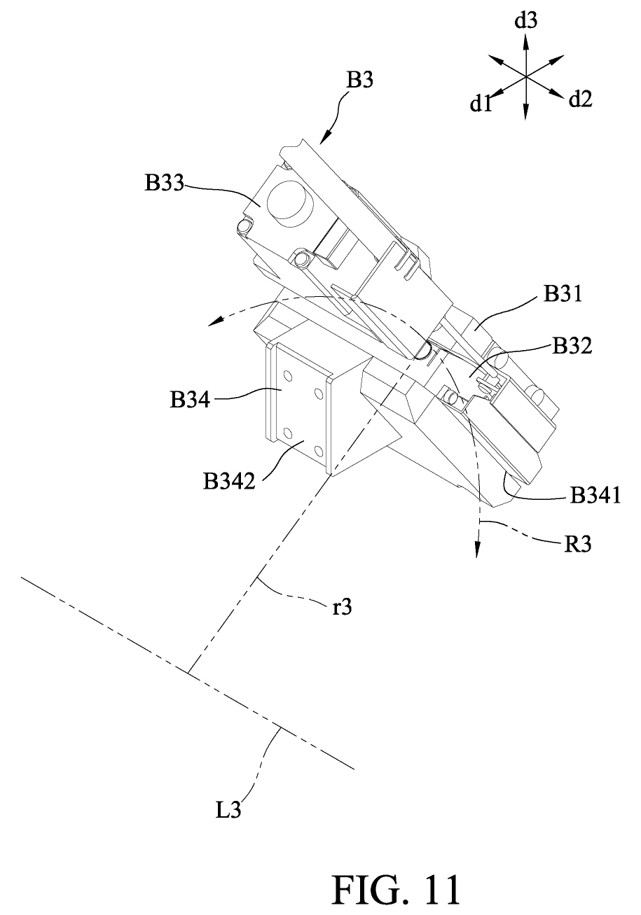

With reference to FIGS. 8 and 11, the third rotatable assembly (B3) is operable to drive the retention mechanism (C) to rotate about a third axis (L3), and includes a third base seat (B31) mounted to the second connecting member (B24) (see FIG. 10), a third movable seat (B32) mounted to the third base seat (B31), a third driver (B33) operable to drive the third movable seat (B32) to move, and a third connecting member (B34) mounted to the third movable seat (B32). The third base seat (B31) is formed with an arcuate concave surface that faces the third movable seat (B32). The third movable seat (B32) is formed with an arcuate convex surface that faces the third base seat (B31) and that is complementary in shape with the arcuate concave surface of the third base seat (B31). The third movable seat (B32) is driven by the third driver (B33) to move arcuately along the third base seat (B31) so that the third connecting member (B34) is driven thereby to move along a third arcuate path (R3) front and rear as depicted in FIG. 11. The third movable seat (B32) rotates about the third axis (L3) that is parallel to the second direction (d2). As shown in FIG. 11, a distance between each of a plurality of points on the third arcuate path (R3) and the third axis (L3) is defined as a third radius (r3). In this embodiment, the third base seat (B31) and the third movable seat (B32) are movable relative to each other through a cross bearing, but the present disclosure is not limited hereto.

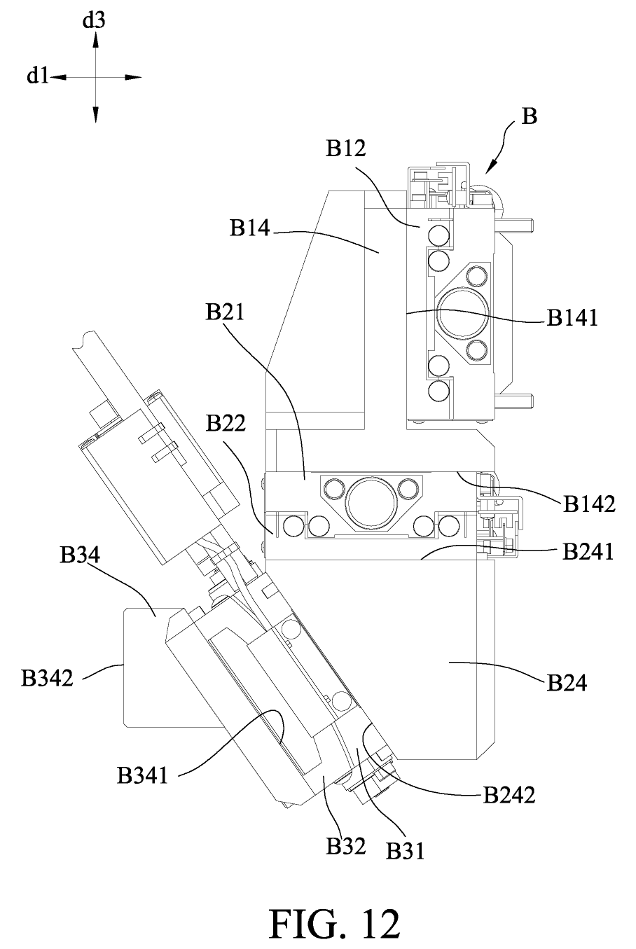

Referring to FIGS. 8 and 12, the first connecting member (B14) has a first connection surface (B141) extending vertically and a second connection surface (B142) extending horizontally. The second connecting member (B24) has a third connection surface (B241) extending horizontally and a fourth connection surface (B242) extending inclinedly. The third connecting member (B34) has a fifth connection surface (B341) extending inclinedly and a sixth connection surface (B342) extending vertically. The first connection surface (B141) is substantially parallel to the sixth connection surface (B342). The fourth connection surface (B242) is substantially parallel to the fifth connection surface (B341). The first connection surface (B141) of the first connecting member (B14) is mounted to the first movable seat (B12) of the first rotatable assembly (B1). The second rotatable assembly (B2) is disposed under the first connecting member (B14) in the third direction (d3). The second base seat (B21) is mounted to the second connection surface (B142) of the first connecting member (B14). The third connection surface (B241) of the second connecting member (B24) is mounted to the second movable seat (B22). The third base seat (B31) of the third rotatable assembly (B3) is mounted to the fourth connection surface (B242) of the second connecting member (B24) that is inclined. The fifth connection surface (B341) of the third connecting member (B34) that is inclined is mounted to the third movable seat (B32). The retention mechanism (C) (see FIG. 7) is mounted to the sixth connection surface (B342).

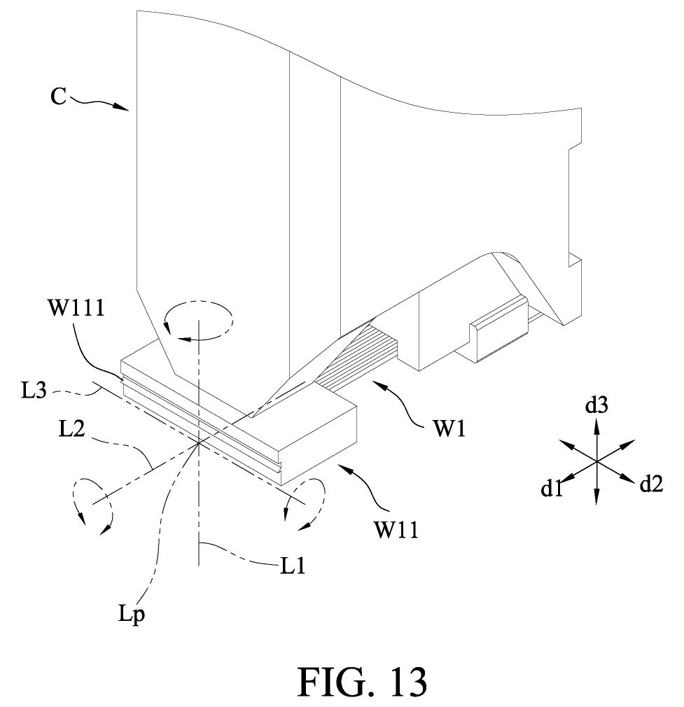

Referring to FIG. 13, the first axis (L1), the second axis (L2), and the third axis (L3) are normal to each other and intersect at an axial point (Lp). The rotation drive mechanism (B) is operable to drive the retention mechanism (C) to drive rotations of the fiber array unit (W1) with the axial point (Lp) serving as a rotational center. Specifically, one or more of the first rotatable assembly (B1), the second rotatable assembly (B2), and the third rotatable assembly (B3), drives rotations of the retention mechanism (C) such that the retention mechanism (C) drives the fiber array unit (W1) to rotate about one or more of the first axis (L1), the second axis (L2), and the third axis (L3). The axial point (Lp) is located at a position under the optical coupler (W11) of the fiber array unit (W1) in the third direction (d3) and in front of the prism (W111) of the fiber array unit (W1) in the first direction (d1) when the retention mechanism (C) retains the fiber array unit (W1). As shown in FIG. 5, when the fiber array unit (W1) is coupled to the integrated circuit component (W2), a lower region of the optical coupler (W11) and a front region of the prism (W111) are substantially disposed above an upper surface of the photonic integrated circuit (W23) and correspond in position to the lens array (W231). In other embodiments, the first axis (L1), the second axis (L2), and the third axis (L3) may merely intersect with each other.

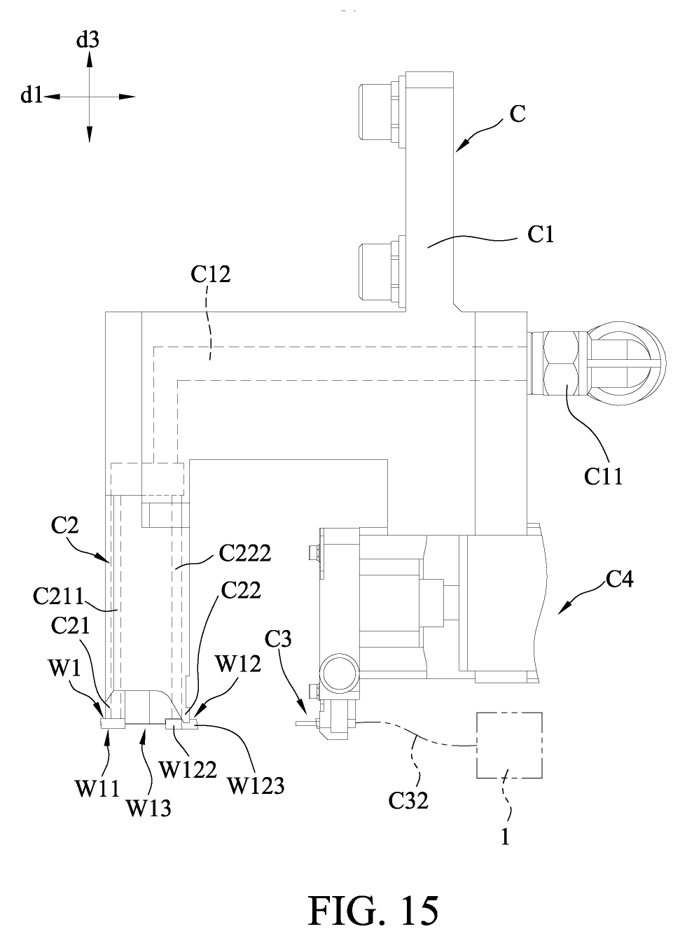

Referring to FIGS. 14 and 15, the retention mechanism (C) includes a support frame (C1), a retention member (C2) mounted to the support frame (C1) and for retaining the fiber array unit (W1), a connector member (C3) mounted to the support frame (C1) and connected to the measurement unit 1, a drive unit (C4) mounted to the support frame (C1) and operable to drive the connector member (C3) to move along the first direction (d1), and a curing unit (C5) disposed on the support frame (C1) and for curing the first adhesive (F1) and the second adhesive (F2). As shown in FIG. 15, the support frame (C1) is formed with an air passage (C12) in fluid communication with a valve (C11). The valve (C11) is in fluid communication with a negative pressure source (not shown). The retention member (C2) and the connector member (C3) are mounted to the support frame (C1) and are co-movable with the support frame (C1). The connector member (C3) is movable relative to the retention member (C2) in the first direction (d1), and is detachably connected to the fiber array unit (W1). In this way, the retention mechanism (C) not only retains the fiber array unit (W1) but is also beneficial for the measurement unit 1 in measuring the intensity of the optical signal (W3) transmitted back to the fiber array unit (W1).

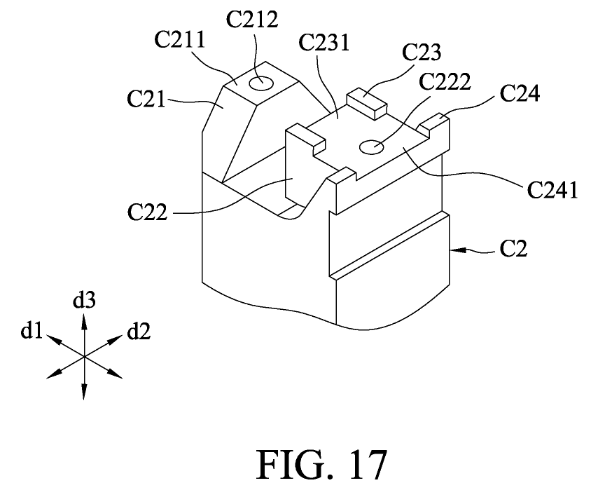

Referring to FIGS. 15 to 17, the retention member (C2) includes a first retention portion (C21) and a second retention portion (C22) spaced apart from the first retention portion (C21) in the first direction (d1). The first retention portion (C21) is for retaining the optical coupler (W11) of the fiber array unit (W1). The second retaining portion (C22) is for retaining the receptacle portion (W12) of the fiber array unit (W1). In this way, the retention member (C2) securely retains two opposite ends of the fiber array unit (W1), thereby reducing a possibility that the fiber array unit (W1) falls off from the retention mechanism (C). The first retention portion (C21) has a first retention surface (C211) and a first negative pressure hole (C212) that is formed through the first retention surface (C211) and that is in fluid communication with the air passage (C12). The first retention surface (C211) is operable to be in contact with the optical coupler (W11) of the fiber array unit (W1) for picking up the same through the first negative pressure hole (C212). The second retention portion (C22) has a second retention surface (C221) and a second negative pressure hole (C222) that is formed through the second retention surface (C221) and that is in fluid communication with the air passage (C12). The second retention surface (C221) is operable to be in contact with the receptacle portion (W12) of the fiber array unit (W1) for picking up the same through the second negative pressure hole (C222). The retention member (C2) further includes a first limit portion (C23) and a second limit portion (C24). The first limit portion (C23) is disposed on one side of the second retention portion (C22) that is adjacent to the first retention portion (C21). The second limit portion (C24) is disposed on another side of the second retention portion (C22) away from the first retention portion (C21) and has a width in the second direction (d2) greater than a width of the first limit portion (C23) in the second direction (d2). The first limit portion (C23) includes a first accommodating region (C231) for the optical fiber portion (W13) of the fiber array unit (W1) to extend therethrough. The second limit portion (C24) includes a second accommodating region (C241) for the second seat portion (W123) of the receptacle portion (W12) of the fiber array unit (W1) to extend therethrough. The first limit portion (C23) and the second limit portion (C24) are provided to, when the fiber array unit (W1) is retained by the retention member (C2), limit movement of the first seat portion (W122) of the receptacle portion (W12) that has the width in the second direction (d2) larger than the width of the second seat portion (W123) in the second direction (d2). In this way, the first limit portion (C23) and the second limit portion (C24) are provided to limit movement of the fiber array member (W1) relative to the retention member (C2) in the first direction (d1).

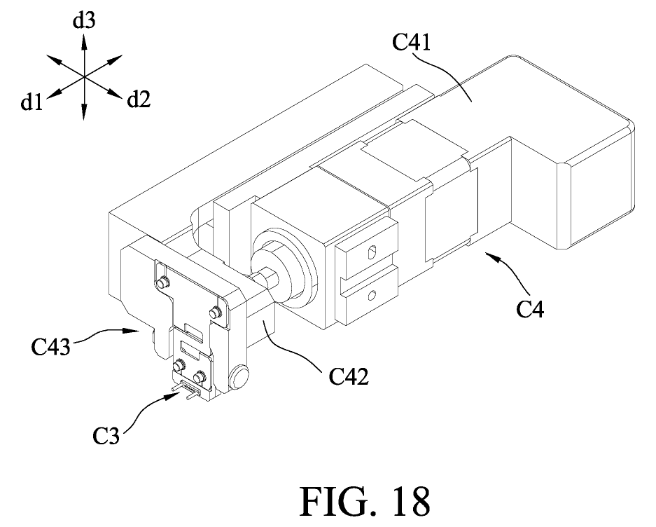

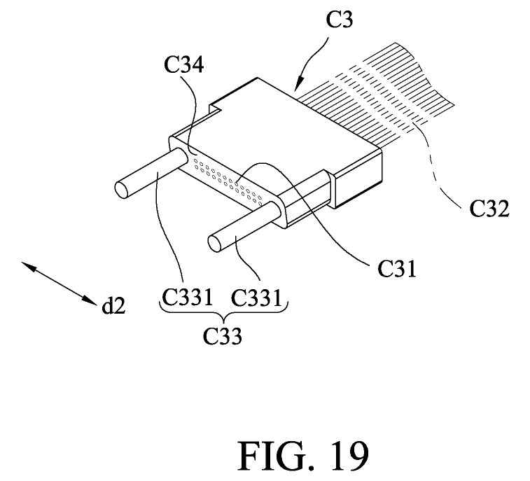

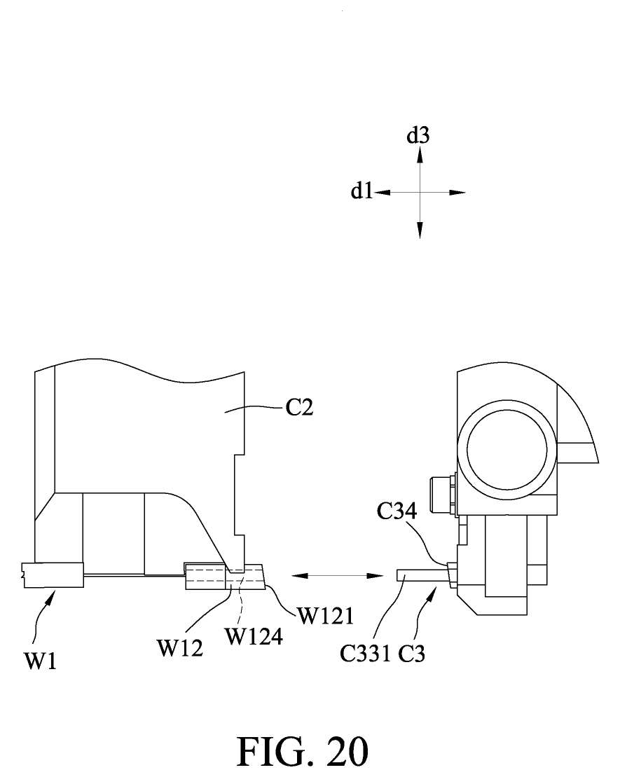

Referring to FIGS. 15, and 18 to 20, the connector member (C3) is mounted to the support frame (C1) via the drive unit (C4). The drive unit (C4) includes a driver member (C41), a movable member (C42) that is driven by the driver member (C41) to move, and a mounting seat (C43) that is mounted to the movable member (C42). The connector member (C3) is mounted to the mounting seat (C43) that is driven by the driver member (C41) to move relative to the retention member (C2) in the first direction (d1), and is detachably connected to the fiber array member (W1). The connector member (C3) includes a light passage portion (C31), a light transmission portion (C32) connected between the light passage portion (C31) and the measurement unit 1, and a guiding portion (C33) inserted into the fiber array unit (W1) when being connected thereto. The light passage portion (C31) and the guiding portion (C33) are formed on an abutment surface (C34) of the connector member (C3) that faces the retention member (C2) and that is tilted inwardly from the top to the bottom (see FIG. 20). An inclination degree of the abutment surface (C34) relative to the horizontal plane is the same as an inclination degree of the second side surface (W121) of the receptacle portion (W12) of the fiber array unit (W1) relative to the horizontal plane. Specifically, the abutment surface (C34) and the second side surface (W121) are parallel to and complementary with each other. As shown in FIG. 19, the guiding portion (C33) includes two guide pins (C331) spaced apart from each other in the second direction (d2) and respectively inserted into the two guide holes (W124) of the receptacle portion (W12) when being connected to the fiber array unit (W1). When the guide pins (C331) are respectively inserted into the guide holes (W124), the abutment surface (C34) abuts against the second side surface (W121) and the light passage portion (C31) corresponds in position to the optical fiber portion (W13) of the fiber array unit (W1), such that the optical signal (W3) (see FIG. 5) outputted from the measurement unit 1 (see FIG. 15) may be transmitted to the fiber array unit (W1).

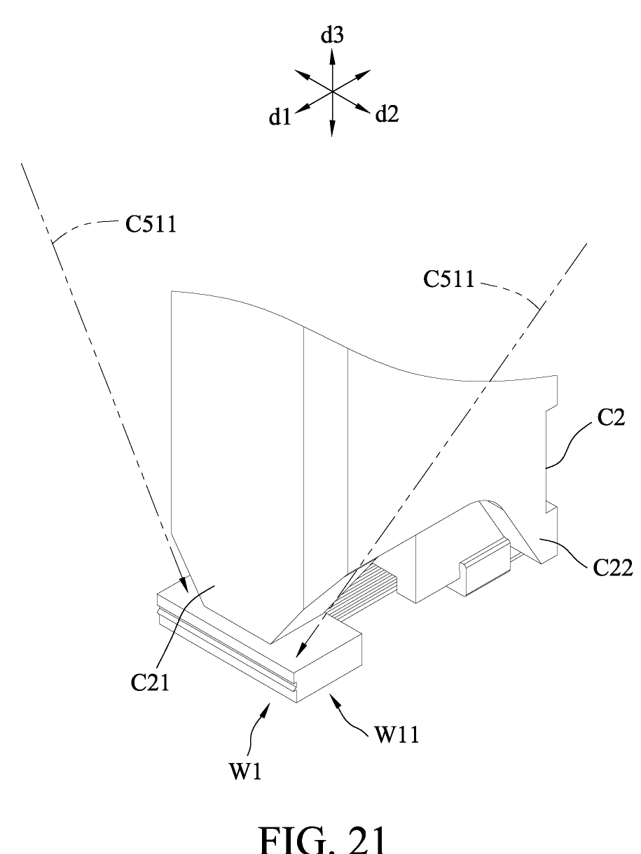

Referring to FIGS. 14, 16, and 21, the curing unit (C5) includes two first cure elements (C51) that are spaced apart from each other in the second direction (d2). The first cure elements (C51) are operable to emit ultraviolet light (C511) toward the first retention portion (C21) of the retention member (C2). In other embodiments, the curing unit (C5) further includes two second cure elements (not shown) that are operable to emit laser light or blow hot air toward the second retention portion (C22) of the retention member (C2) to cure the second adhesive (F2). It should be noted that the numbers of the first cure elements (C51) and the second cure elements are not limited to these embodiments.

In this embodiment, the fiber array unit (W1) is disposed on the first stage device 3 and the integrated circuit component (W2) is disposed on the second stage device 4. The linear driving mechanism (A) drives the inspection mechanism (D) to move horizontally to be above the second stage device 4, and the inspection mechanism (D) obtains, e.g., by image capturing or distance measuring, etc., the position of the photonic integrated circuit (W23) and/or the lens array (W231) of the photonic integrated circuit (W23), and the inclination degree of the upper surface of the photonic integrated circuit (W23) relative to the horizontal plane. The control unit 7 is electrically connected to the inspection mechanism (D) and is configured to store the position of the photonic integrated circuit (W23) and/or the lens array (W231) and the inclination degree of the upper surface of the photonic integrated circuit (W23) upon receipt of the same. For example, the measurement unit 1 may be a passive optical component testing platform including a tunable laser module, a switch, a polarizer, and a test instrument for testing Wavelength Division Multiplexing (WDM) devices and photonic integrated circuits. It should be noted that, in this embodiment, each of the measurement unit 1 and the control unit 7 includes a microcontroller unit or is a control unit such as, but not limited to, a single core processor, a multi-core processor, a dual-core mobile processor, a microprocessor, a microcontroller unit, a digital signal processor (DSP), a field-programmable gate array (FPGA), an application specific integrated circuit (ASIC), a radio-frequency integrated circuit (RFIC), etc. In addition, each of the measurement unit 1 and the control unit 7 may be embodied in: executable software as a set of logic instructions stored in a machine- or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof.

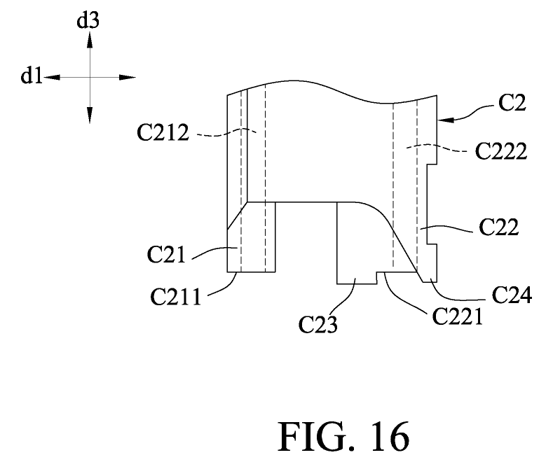

After the position of the photonic integrated circuit (W23) and/or the lens array (W231) and the inclination degree of the upper surface of the photonic integrated circuit (W23) are obtained, the linear driving mechanism (A) drives the rotation drive mechanism (B) to drive the retention mechanism (C) to move horizontally in the second direction (d2) to be above the first stage device 3. Then, the linear driving mechanism (A) drives the rotation drive mechanism (B) to move together with the retention mechanism (C) downwardly in the third direction (d3) so that the retention member (C2) comes into contact with the fiber array unit (W1) carried on the first stage device 3. At the same time, as shown in FIGS. 15 and 16, the negative pressure source connected to the valve (C11) is turned on such that the first retention portion (C21) and the second retention portion (C22) of the retention member (C2) respectively suck and retain the optical coupler (W11) and the receptacle portion (W12) of the fiber array unit (W1) to pick up the fiber array unit (W1). Subsequently, the drive unit (C4) drives the connector member (C3) to move toward the fiber array unit (W1) to connect the connector member (C3) to the fiber array unit (W1), so the optical signal (W3) outputted from the measurement unit 1 may be transmitted to the fiber array unit (W1).

After the connector member (C3) is connected to the fiber array unit (W1), the linear driving mechanism (A) drives the rotation drive mechanism (B) to drive upward movement of the retention mechanism (C), such that the retention member (C2) picks up and retains the fiber array unit (W1) to move the fiber array unit (W1) away from the first stage device 3. Then, the linear driving mechanism (A) drives the rotation drive mechanism (B) to move horizontally in the second direction (d2) toward the detection station 6, so that the detection station 6 inspects a posture of the optical coupler (W11), e.g., by image capturing or distance measuring, etc., to obtain a position of the optical coupler (W11) and/or the prism (W111) of the fiber array unit (W1), and obtain an inclination degree of a lower surface of the optical coupler (W11) relative to the horizontal plane. The control unit 7 stores the position of the optical coupler (W11) and/or the prism (W111) and the inclination degree of the lower surface of the optical coupler (W11) upon receipt of the same. Referring to FIGS. 6, 10 and 15, the control unit 7 is configured to compare the position of the optical coupler (W11) and/or the prism (W111) with the position of the photonic integrated circuit (W23) and/or the lens array (W231) to obtain a position deviation, and to control, according to the position deviation, the first rotatable assembly (B1) of the rotation drive mechanism (B) to rotate about the first axis (L1) along the first arcuate path (R1) left and right as depicted in FIGS. 9 and 13. In this way, a posture (the position and/or the inclination degree) of the fiber array unit (W1) retained by the retention mechanism (C) is adjusted such that the position of the optical coupler (W11) and/or the prism (W111) is registered with the position of the photonic integrated circuit (W23) and/or the lens array (W231) as shown in FIG. 1.

Similarly, the control unit 7 is configured to compare the inclination degree of the lower surface of the optical coupler (W11) with the inclination degree of the photonic integrated circuit (W23) to obtain an inclination deviation, and to control, according to the inclination deviation, the second rotatable assembly (B2) of the rotation drive mechanism (B) to rotate about the second axis (L2) along the second arcuate path (R2) up and down as depicted in FIGS. 12 and 15 and the third rotatable assembly (B3) to rotate about the third axis (L3) along the third arcuate path (R3) front and rear as depicted in FIGS. 13 and 15. In this way, the posture of the fiber array unit (W1) retained by the retention mechanism (C) is adjusted such that the lower surface of the optical coupler (W11) is parallel to the upper surface of the photonic integrated circuit (W23).

After the rotation drive mechanism (B) drives the retention mechanism (C) to adjust the position of the fiber array unit (W1) and the inclination degree of the lower surface of the optical coupler (W11), the linear driving mechanism (A) drives the rotation drive mechanism (B) to move the retention mechanism (C) horizontally toward the adhesive coating station 5 for coating adhesive. The adhesive coating station 5 includes two adhesive valves for respectively discharging the first adhesive (F1) and the second adhesive (F2) onto the lower surface of the optical coupler (W11) and a lower surface of the receptacle portion (W12).

After the first adhesive (F1) and the second adhesive (F2) are coated onto the fiber array unit (W1), the linear driving mechanism (A) drives the rotation drive mechanism (B) to move the retention mechanism (C) horizontally to a position above the second stage device 4. Since the rotation drive mechanism (B) moves the retention mechanism (C) such that the optical coupler (W11) and/ or the prism (W111) corresponds in position to the photonic integrated circuit (W23) and/or the lens array (W231) and since the lower surface of the optical coupler (W11) is adjusted to be parallel to the upper surface of the photonic integrated circuit (W23) when the posture of the optical coupler (W11) is adjusted, after the retention mechanism (C) is moved to the position above the second stage device 4, the linear driving mechanism (A) directly drives the rotation drive mechanism (B) to move together with the retention mechanism (C) downwardly in the third direction (d3), so the lower surface of the optical coupler (W11) and the lower surface of the receptacle portion (W12) are respectively adhered to the upper surface of the photonic integrated circuit (W23) and an upper surface of the second lid portion (W222) of the lid unit (W22) respectively via the first adhesive (F1) and the second adhesive (F2). In this way, the optical signal (W3) may be transmitted between the fiber array unit (W1) and the integrated circuit component (W2) via the prism (W111) and the lens array (W231). At this time, the fiber array unit (W1) is still retained by the retention member (C2) of the retention mechanism (C).

After the fiber array unit (W1) is disposed on the integrated circuit component (W2), because each of the first adhesive (F1) and the second adhesive (F2) has a certain thickness in the third direction (d3) and is not cured yet, the fiber array unit (W1) floats on the first adhesive (F1) and the second adhesive (F2) and the posture of the fiber array unit (W1) is adjustable by the retention mechanism (C).

At this time, the measurement unit 1 may measure the intensity of the optical signal (W3) such that the control unit 7 determines whether the intensity of the optical signal (W3) falls within a predetermined range. When the control unit 7 determines that the intensity of the optical signal (W3) does not fall within the predetermined range, the control unit 7 controls the rotation drive mechanism (B) to drive rotations of the fiber array unit (W1) with the axial point (Lp) serving as the rotational center, where the fiber array unit (W1) is rotatable about one or more of the first axis (L1), the second axis (L2), and the third axis (L3) with three degrees of freedom. Thus, the posture of the fiber array unit (W1) may be slightly adjusted when the fiber array unit (W1) is disposed on the integrated circuit component (W2) until the intensity of the optical signal (W3) falls within the predetermined range. At this time, the control unit 7 controls the rotation drive mechanism (B) to stop moving.

When it is determined that the intensity of the optical signal (W3) falls within the predetermined range, transmission performance of the optical signal (W3) between the fiber array unit (W1) and the integrated circuit component (W2) is relatively good.

It should be noted that the order of operations of the rotation drive mechanism (B) is prioritized by the third rotatable assembly (B3), followed by the second rotatable assembly (B2) and then the first rotatable assembly (B1). When the intensity of the optical signal (W3) measured by the measurement unit 1 is determined by the control unit 7 to be within the predetermined range after driving of the third rotatable assembly (B3), the first rotatable assembly (B1) and the second rotatable assembly (B2) are not required to be driven. When the control unit 7 determines that the intensity of the optical signal (W3) still does not fall within the predetermined range after the rotation drive mechanism (B) drives the retention mechanism (C) to slightly adjust the posture of the fiber array unit (W1), the control unit 7 controls the linear driving mechanism (A) to drive the rotation drive mechanism (B) together with the retention mechanism (C) to move the fiber array unit (W1) linearly in one or more of the first direction (d1), the second direction (d2), and the third direction (d3) with three degrees of freedom. Then, the control unit 7 controls the rotation drive mechanism (B) to drive the retention mechanism (C) to drive rotations of the fiber array unit (W1) about one or more of the first axis (L1), the second axis (L2), the third axis (L3) with three degrees of freedom to adjust the posture of the fiber array unit (W1). The fiber array unit (W1) may be adjusted to a relatively large extent when being disposed on the integrated circuit component (W2) until the intensity of the optical signal (W3) measured by the measurement unit 1 falls within the predetermined range. Then, the control unit 7 controls the linear driving mechanism (A) and the rotation drive mechanism (B) to stop movement and rotation.

When the intensity of the optical signal (W3) falls within the predetermined range, the curing unit (C5) cures the first adhesive (F1) by emitting the ultraviolet light (C511) and cures the second adhesive (F2) by emitting laser light or hot air. It should be noted that since the optical coupler (W11) is made of a light-transmissive material, the ultraviolet light (C511) may propagate through the optical coupler (W11) and cure the first adhesive (F1). In one embodiment, the second adhesive (F2) is heat cured adhesive, since the laser light is capable of generating heat, laser light or hot air (not shown) is emitted from the second cure elements (not shown) to heat and cure the second adhesive (F2). After the first adhesive (F1) and the second adhesive (F2) are cured, the control unit 7 drives the drive unit (C4) to drive movement of the connector member (C3) away from the fiber array unit (W1) so the connector member (C3) is detached from the fiber array unit (W1). Finally, after the connector member (C3) is detached from the fiber array unit (W1), the negative pressure source is turned off and the retention member (C2) moves away from the fiber array unit (W1) to complete the process of coupling the fiber array unit (W1) to the integrated circuit component (W2).

It may be appreciated that a predetermined number of the fiber array units (W1) may be sequentially coupled to the photonic integrated circuit (W23) of the integrated circuit component (W2) by repeating the abovementioned operations, i.e., by the linear driving mechanism (A) and the rotation drive mechanism (B) driving the retention mechanism (C) of the coupling device 2.

To sum up, the embodiment of the present disclosure provides the rotation drive mechanism (B) including the first movable seat (B12), the second movable seat (B22), and the third movable seat (B32) respectively movable arcuately along the first base seat (B11), the second base seat (B21), and the third base seat (B31) to fine-tune the posture (the position and/or the inclination degree) of the fiber array unit (W1) relative to the integrated circuit component (W2) such that the intensity of the optical signal (W3) transmitted between the fiber array unit (W1) and the integrated circuit component (W2) may fall within a predetermined range to provide a relatively reliable and efficient transmission performance of the optical signal (W3).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to lid various arrangements included within the spirit and scope of the broadest interpretation so as to encompass all such modifications and equivalent arrangements.

What is claimed is:

1. A rotation drive mechanism comprising:
a plurality of rotatable assemblies, each of said plurality of rotatable assemblies includes a base seat and a movable seat driven to move arcuately along said base seat along an arcuate path about an axis.

2. The rotation drive mechanism as claimed in claim 1, wherein:
each of said plurality of rotatable assemblies includes a connecting member; and
said connecting member of one of said plurality of rotatable assemblies is connected to said movable seat of said one of said plurality of rotatable assemblies and said base seat of another one of said plurality of rotatable assemblies.

3. The rotation drive mechanism as claimed in claim 1, wherein:
the axes that said movable seats of said plurality of rotatable assemblies move about intersect at an axial point.

4. The rotation drive mechanism as claimed in claim 3, adapted to be mounted to a retention mechanism retaining a fiber array unit, wherein:
said rotation drive mechanism is adapted to drive the retention mechanism to rotate about the axes with the axial point serving as a rotational center.

5. The rotation drive mechanism as claimed in claim 1, wherein:
said plurality of rotatable assemblies includes a first rotatable assembly, a second rotatable assembly, and a third rotatable assembly;
said first rotatable assembly includes a first base seat and a first movable seat mounted to said first base seat and movable arcuately along said first base seat and along a first arcuate path about a first axis;
said second rotatable assembly includes a second base seat and a second movable seat mounted to said second base seat and movable arcuately along said second base seat and along a second arcuate path about a second axis;
said third rotatable assembly includes a third base seat and a third movable seat mounted to said third base seat and movable arcuately along said third base seat and along a third arcuate path about a third axis; and
the first axis, the second axis and the third axis are normal to each other.

6. The rotation drive mechanism as claimed in claim 5, wherein:
the second axis is parallel to a first direction that is a horizontal direction;
the third axis is parallel to a second direction that is another horizontal direction and that is normal to the first direction; and
the first axis is parallel to a third direction that is a vertical direction normal to the first direction and the second direction.

7. The rotation drive mechanism as claimed in claim 5, wherein:
said first rotatable assembly further includes a first connecting member mounted to said first movable seat;
said second rotatable assembly further includes a second connecting member mounted to said second movable seat;
said third rotatable assembly further includes a third connecting member mounted to said third movable seat;
said second base seat is mounted to said first connecting member; and
said third base seat is mounted to said second connecting member.

8. The rotation drive mechanism as claimed in claim 7, wherein:
said first connecting member has a first connection surface extending vertically and a second connection surface extending horizontally;
said second connecting member has a third connection surface extending horizontally and a fourth connection surface extending inclinedly;
said third connecting member has a fifth connection surface extending inclinedly and a sixth connection surface extending vertically;
said first connection surface is substantially parallel to said sixth connection surface; and
said fourth connection surface is substantially parallel to said fifth connection surface.

9. The rotation drive mechanism as claimed in claim 8, wherein:
said first connection surface of said first connecting member is mounted to said first movable seat;
said second rotatable assembly is disposed under said first connecting member in the third direction;
said second base seat is mounted to said second connection surface of said first connecting member;
said third connection surface of said second connecting member is mounted to said second movable seat;
said third base seat of said third rotatable assembly is mounted to said fourth connection surface of said second connecting member that is inclined; and
said fifth connection surface of said third connecting member that is inclined is mounted to said third movable seat.

10. The rotation drive mechanism as claimed in claim 7 adapted to be mounted to a retention mechanism retaining a fiber array unit, wherein:
said third connecting member has a fifth connection surface extending inclinedly and a sixth connection surface extending vertically; and
said sixth connection surface is adapted for mounting of the retention mechanism.

11. The rotation drive mechanism as claimed in claim 1, adapted to be disposed on a linear driving mechanism that is driven to move linearly in a plurality of directions, wherein:
said rotation drive mechanism is adapted to be driven by the linear driving mechanism to move linearly in a plurality of directions.

12. A driving method adapted for moving a fiber array unit, comprising steps of:
retaining, with a retention mechanism, the fiber array unit;
driving the retention mechanism by a rotation drive mechanism that includes a plurality of rotatable assemblies; and
driving a movable seat of each of the plurality of rotatable assemblies to move arcuately along a base seat of the respective one of the plurality of rotatable assemblies along an arcuate path about an axis.

13. The driving method as claimed in claim 12, wherein:
the axes that the movable seats of the plurality of rotatable assemblies move about intersect at an axial point.

14. A rotation drive mechanism for performing the driving method as claimed in claim 12, wherein said rotation drive mechanism comprises a plurality of rotatable assemblies.

15. A coupling method adapted to couple a fiber array unit to an integrated circuit component, comprising steps of:
retaining, with a retention mechanism, the fiber array unit;
driving the retention mechanism by a rotation drive mechanism that includes a plurality of rotatable assemblies such that the fiber array unit is moved toward the integrated circuit component;
measuring an intensity of an optical signal transmitted between the fiber array unit and the integrated circuit component; and
driving a movable seat of each of the plurality of rotatable assemblies to move arcuately along a base seat of the respective one of the plurality of rotatable assemblies along an arcuate path about an axis, such that the retention mechanism is driven to adjust a posture of the fiber array unit according to the intensity of the optical signal until the intensity falls within a predetermined range.

16. A coupling device adapted to perform the coupling method as claimed in claim 15, wherein said coupling device comprises a plurality of rotatable assemblies.
